(19) United States
(12) Patent Application Publication
(10) Pub. No.: US 2013/0262256 A1
(43) Pub. Date: Oct. 3, 2013

(54) METHOD AND SYSTEM TO RECONSTRUCT AN ON-LINE EXPERIENCE

(71) Applicant: David Goldberg, Palo Alto, CA (US)

(72) Inventor: David Goldberg, Palo Alto, CA (US)

(73) Assignee: eBay Inc., San Jose, CA (US)

(21) Appl. No.: 13/436,101

(22) Filed: Mar. 30, 2012

(51) Int. Cl. G06Q 30/08; G06F 17/00; G06F 15/16

(52) U.S. Cl. 705/26.3; 709/204; 715/202

(57) ABSTRACT

A method and system to reconstruct an on-line experience is provided. An example system includes a recording module, a completion trigger detector, a storing module, and a report generator. The recording module may be configured to commence recording of notes provided by an expert user. The completion trigger detector may be configured to detect a completion trigger indicating a completed set of on-line activities with respect to a certain goal. The storing module may associate the notes with respective context information and store the notes for later use. The report generator may be configured to generate a report outlining the associated on-line experience, based on the stored notes.

### TECHNICAL FIELD

This application relates to the technical fields of software and/or hardware technology and, in one example embodiment, to system and method to reconstruct an on-line experience.

### BACKGROUND

An on-line trading platform allows users to shop for almost anything using a web browser application. A user may find an item listed by an on-line trading application by entering keywords into the search box provided on an associated web page or by browsing through the list of categories on the home page. After reading the item description and viewing the seller's reputation, the user may be able to either place a bid on the item or purchase it instantly. An on-line trading application may permit incremental bidding where the system bids on the user's behalf up to the user-specified maximum bid. There are many features provided by an on-line trading application that may be utilized by users in unique ways that may result in a successful shopping experience.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to reconstruct an on-line experience may be implemented;

FIG. 2 is block diagram of a system to reconstruct an on-line experience, in accordance with one example embodiment;

FIG. 3 is a flow chart of a method to reconstruct an on-line experience, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to reconstruct an on-line experience is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

As mentioned above, an on-line trading system may provide a variety of features that may be utilized by users in unique ways to create a successful shopping experience. Some users may be more experienced than others in navigating these features. A method and system described herein facilitate an opportunity for users to follow the searches performed by another user, e.g., a user who may be considered an expert shopper. A search experience, starting with the time when a user first submits a search request for an item and ending with completing a transaction with respect to that item, might take place over many days. A user might want to share her successful shopping experience with the community, but may not want do it until after the desired item has been purchased, e.g., in order to avoid competition for a bargain item of limited availability or in order to avoid competition for an auction item.

An on-line trading system may be configured to permit users to subscribe to activities of another user. Such other user may be termed an expert user for the purposes of this description, to merely indicate that the user has followers. When an expert user performs certain on-line activities while annotating at least some of the actions performed with respect to a certain goal, a report is generated based on the annotations (or notes) and released to the followers. The followers are those users of the on-line trading platform who subscribed to activities of another user (an expert user). The notes of an expert user describing her on-line experience may be released to the followers in response to a predetermined condition, such as the successful completion of an associated transaction or an explicit request by the expert user. In one example embodiment, the followers are those users of an on-line system (e.g., the on-line trading platform) who subscribed to activities of another user (an expert user). While the description below relates to collecting, processing, and releasing the notes of an expert user with respect to an on-line trading system, the methodologies described herein may be used advantageously in situations where a user performing on-line activities is willing to annotate and share his experience but is not willing to release his notes to followers until a certain embargo period.

For example, a user may be aware that a certain company has scheduled a new product announcement for a certain date. The user may be able to hunt around on the web to get clues on the announcement, while recording his notes, and make a prediction about what will be announced. If the user's prediction is correct, the user may then release his notes demonstrating how he was able to figure things out in advance. Such user may wish to have his notes embargoed until the actual announcement. Another example of the use case for the methodologies described herein is a user scouring the web for limited quantity offers, such as, for example, free tickets. As the user hunts on the web looking for a free ticket, the user records notes on what he is doing. Once the user has snagged a free ticket, the user releases the notes to followers to show how clever he was in finding the free tickets.

In one example embodiment, as an expert user shops utilizing the on-line trading platform, she is provided, via a user interface, with an option to submit shopping notes to the on-line trading platform. The shopping notes may be submitted in an unstructured format or, e.g., using one or more electronic forms. The shopping notes may be used by an expert user to explain all her clever moves that resulted in a successful transaction.

The shopping notes are not immediately sent to the followers. Instead, they are stored for later use. Only after the expert user has closed the deal are the shopping notes sent out to his followers. In one embodiment, the shopping notes may be compiled into a list and sent directly to followers when the completion of the associated transaction is detected by a detector in the on-line trading platform. In some embodiments, a so-called report generator may be provided in the on-line trading platform that may generate a video that includes screenshots showing the searches and the associated search results, annotated with the shopping notes submitted by the expert user. In some embodiments, while an expert user is shopping and submitting shopping notes, a so-called recording module may be recording the actions of the expert user with respect to the on-line trading platform. The recording may be commenced when an expert user indicates to the on-line trading platform that she is starting the shopping process. After the shopping process has been completed, e.g., after a transaction has been completed by the expert user, a report generator module may create a shopping experience report based on the expert user's shopping notes.

In one embodiment, the report generator accesses the recorded actions of the expert user with respect to the on-line trading platform and creates images of what the associated screens looked like at the time the respective shopping notes were created. For example, if the expert user accessed a certain part of the user interface provided by the on-line trading platform to restrict search results to a particular seller, the report generator module may present in the video the associated portion of the user interface with a mouse moving to ‘Seller,’ clicking on it, then clicking on ‘Specified Sellers,’ etc. In another example, when the log of recorded actions shows a search, the report generator module may recreate the search results web page and include that screen in the generated video. In some embodiments, the report generator module may be configured to only include in the video those actions that provide context to the shopping notes. Another feature that may be provided with the report generator module may include attaching shopping notes to a particular location on the screen. For example, a shopping note “I saw a handbag with no bids” may be attached to the item listing that the shopping note is referring to. In the reconstructed video generated by the report generator module the associated shopping note could appear with an arrow pointing to the item listing. System and method to reconstruct an on-line experience outlined above may be implemented as a shopping notes application and may be provided with an on-line trading platform. An on-line trading platform may also be referred to as a network-based marketplace or publication system.

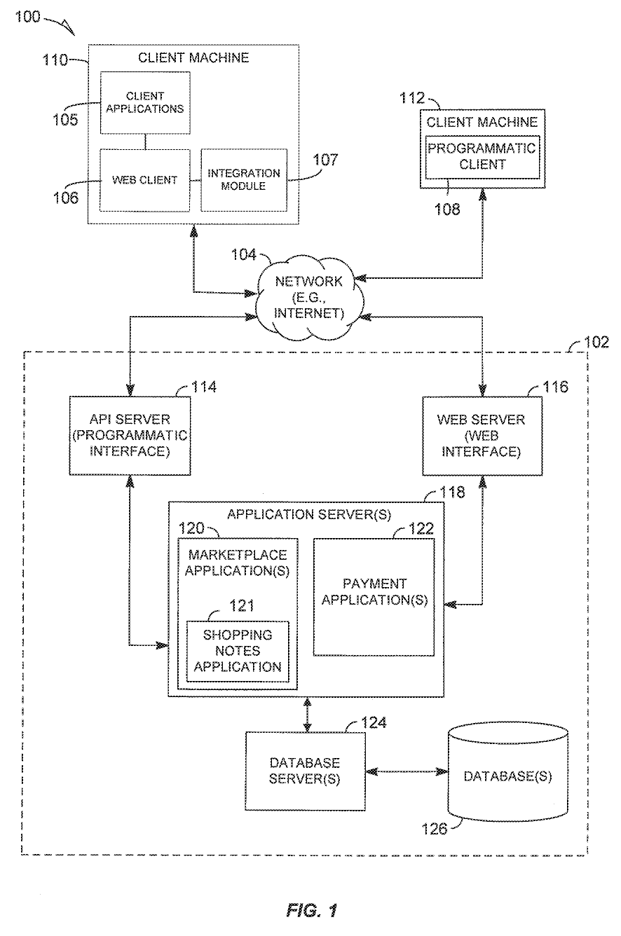

Example method and system to reconstruct an on-line experience may be implemented in the context of a network environment 100 illustrated in FIG. 1.

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, client applications 105 (e.g., mobile applications), an integration module 107, and a web client 106 (e.g., a mobile or desktop Web browser) operating on the client machine 110 (e.g., a mobile device), as well as a programmatic client 108 operating on the client machine 112.

An application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. Shown in FIG. 1 is a shopping notes application 121 included as one of the marketplace applications 120. The shopping notes application 121 may be utilized beneficially to reconstruct an on-line experience as described herein.

The payment applications 122 may provide a number of payment services and functions to users. The payment applications 122 may allow users to accumulate value (e,g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs client-server architecture, the subject matter of the application is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

The integration module 107 on the client machine (e.g., a mobile phone) may submit requests to the marketplace applications 110, through the API server 114, for an up-to-date (e.g., current) publication related to goods and/or services being offered for sale via the networked system 102. A publication related to goods and/or services being offered for sale may also be termed an item listing. Alternatively or additionally the client machine 110 may request one or more current publications from the client machine 112, via the network 104. In various example embodiments, the client machine 112 may provide a current publication to the client machine 110, after generating the current publication or retrieving such a publication from the networked system 102.

In some example embodiments, the integration module is embedded within one or more of the client applications 105 and may collect user parameters, receive targeted current publications based on the user parameters, and cause the display of one or more targeted current publications. A targeted current publication may be displayed among graphics associated with the application in which the integration module is embedded.

The applications 120, including the shopping notes application 121, may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access server one or more databases 126 via the database servers 128.

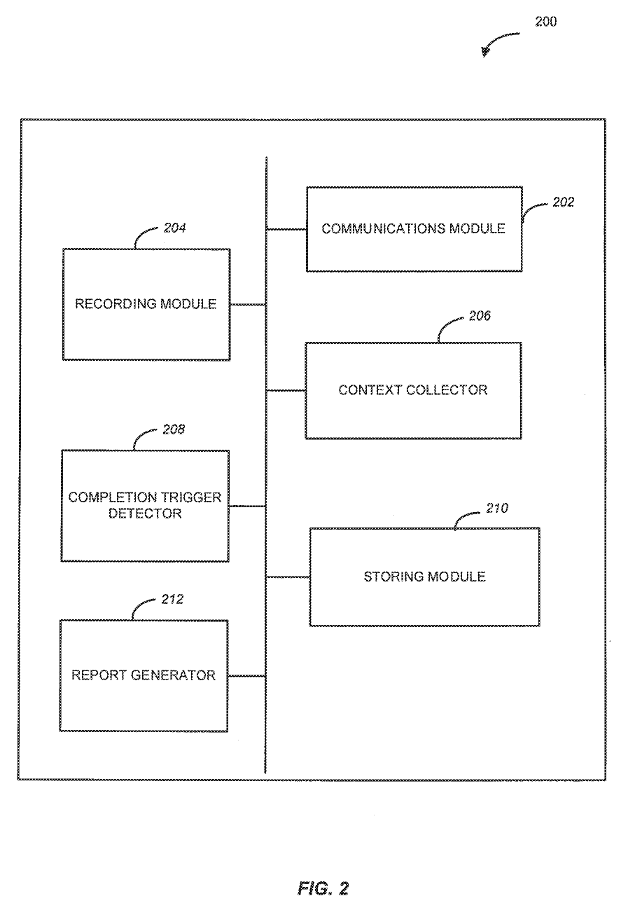

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. An example system corresponding to the shopping notes application 121 of FIG. 1 is illustrated in FIG. 2.

FIG. 2 is a block diagram of a system 200 to reconstruct an on-line experience, in accordance with one example embodiment. As shown in FIG. 2, the system 200 includes a communications module 202, a recording module 204, a context collector 206, a completion trigger detector 208, a storing module 210, and a report generator 212. The communications module 204 may be configured to receive, from a client computer system executing a browser application, notes (e.g., shopping notes) provided by an expert user. As mentioned above, the shopping notes may be associated with one or more searches directed to the on-line trading platform by the expert user and also with search results associated with the one or more searches. The communications module 204 may also be configured to communicate a report (e.g., a shopping experience report) that includes the notes and, possibly, context information, to one or more followers. The communications module 204 may communicate a shopping experience report to one or more follower automatically after the report has been generated or, e.g., in response to detecting a request from a follower user or from the expert user.

The recording module 204 may be configured to commence recording of notes provided by an expert user. The recording of notes may be commenced, e.g., in response to a request by the expert user via a visual control or in response to detecting a note having been submitted by the expert user. The context collector 206 may be configured to collect context information associated with a submitted note, and the recording module 204 may record the note together with the associated context information. Context information associated with a note may include, e.g., a link to a web page associated with the note. Where a note is a shopping note, the context information may be a link to a web page displaying a listing of an item offered for sale in an on-line trading system. Context information may also include identification or an image of an item that is the subject of a search related to a shopping note, seller's information, pricing information, current bid information, etc.

The completion trigger detector 208 may be configured to detect a completion trigger indicating, e.g., a completed transaction with respect to an item or some other pre-determined condition. A completion trigger maybe activated, e.g., utilizing a visual control or by detecting the completion of a transaction associated with the shopping notes. The completion trigger detector 208 may cooperate with the storing module 210. In response to a trigger detected by the completion trigger detector 208, the storing module 210 may associate the notes with a particular event or label and store the notes for later use. For example, the shopping notes may be associated with the item that is the subject of the completed transaction.

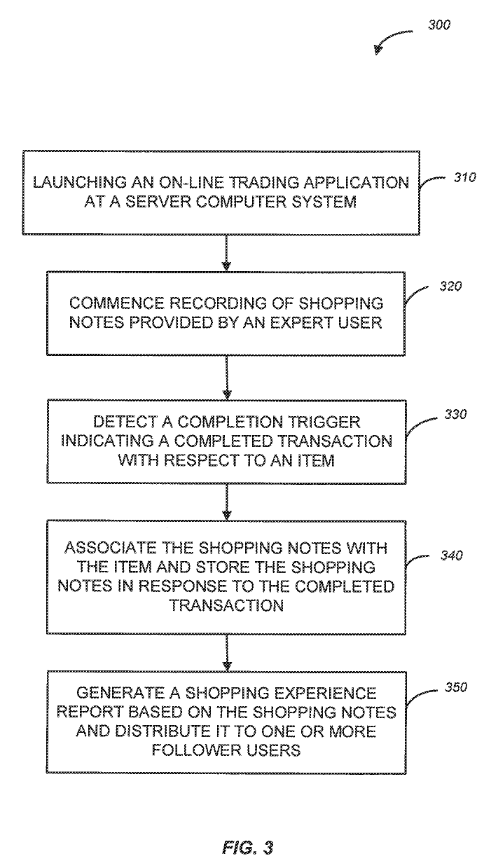

The report generator 212 may be configured to generate a report reflecting the expert user's on-line experience, based on the notes. For example, the report generator 212 may generate a shopping experience report by, e.g., creating a list of the shopping notes. The report generator 212 may also be configured to generate a report utilizing the context information collected by the context collector 206. For example, the report generator 212 may associate the shopping notes with information from one or more web pages generated by the on-line trading application, or by generating a video annotated with the shopping notes. An example method to reconstruct an on-line experience, using an example of an on-line trading platform, can be described with reference to FIG. 3.

FIG. 3 is a flow chart of a method 300 to reconstruct an on-line experience, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, an on-line trading application is launched at a server computer system provided within an on-line trading platform. At operation 320, the recording module 204 of FIG. 2 commences recording of shopping notes provided by an expert user. As mentioned above, the recording of shopping notes may be commenced, e.g., in response to a request by the expert user via a visual control or in response to detecting a shopping note submitted by the expert user. At operation 330, the completion trigger detector 208 of FIG. 2 detects a completion trigger indicating a completed transaction with respect to an item. At operation 330, the storing module 210 of FIG. 2 associates the shopping notes with the item that is the subject of the completed transaction and stores the shopping notes. The report generator 212 generates a shopping experience report at operation 350 and the communications module 202 of FIG. 2. Distributes the shopping experience report to the followers of the expert user.

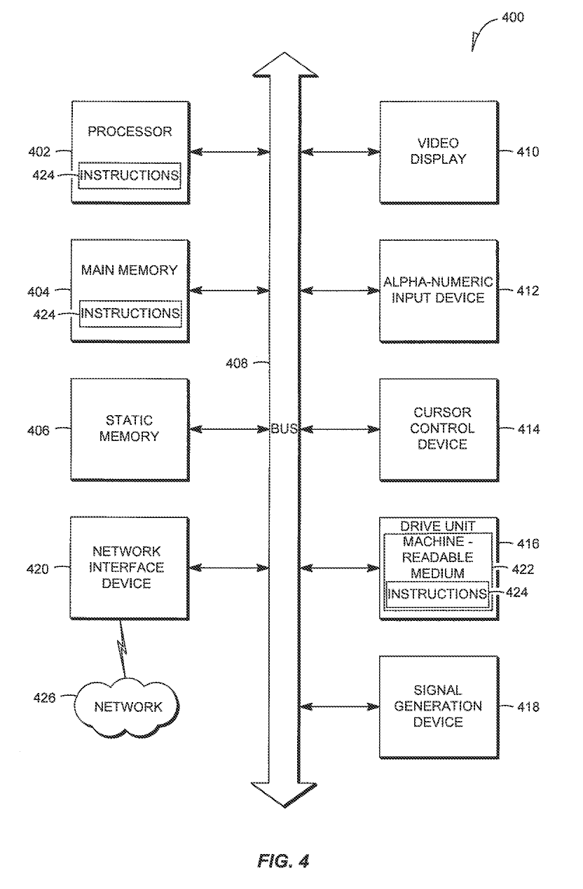

FIG. 4 shows a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 (e.g., a liquid crystal display (LCD) or a cathode ray tube (CRT)). The computer system 400 also includes an alpha-numeric input device 412 (e.g., a keyboard), a user interface (UI) navigation device 414 (e.g., a cursor control device), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402 also constituting machine-readable media.

The software 424 may further be transmitted or received over a network 426 via the network interface device 420 utilizing any one of a number of well-known transfer protocols (e.g., Hyper Text Transfer Protocol (HTTP)).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

Thus, a method and system to reconstruct an on-line experience has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A computer-implemented system comprising:
one or more processors executing an on-line computing application;
a recording module to commence recording of notes provided by an expert user;
a completion trigger detector to detect a completion trigger;
a report generator to generate on-line experience report based on the notes; and
a communications module to communicate the on-line experience report to one or more follower users.

2. The system of claim 1, wherein:
the on-line computing application is an on-line trading application;
the notes provided by an expert user are shopping notes;
the completion trigger is to indicate a completed transaction with respect to an item,
the system comprising a storing module to associate the shopping notes with the item and store the shopping notes in response to the completed transaction.

3. The system of claim 1, comprising:
a communications module to receive, from a client computer system executing a browser application, a note provided by the expert user; and
a context collector to collect context information associated with the note, wherein
the recording module is to rerecord the note together with the context information,
the report generator is to generate the on-line experience report utilizing the notes and the context information.

4. The system of claim 3, wherein the context information comprises a link to a web page associated with the note.

5. The system of claim 1, wherein the report generator is to create a list of the notes.

6. The system of claim 1, wherein the report generator is to associate a note from the notes with web page information, the web page generated by the on-line computing application.

7. The system of claim 1, wherein the report generator is to generate a video, the video annotated with the notes.

8. The system of claim 1, wherein the recording of the notes is associated with one or more searches directed to the on-line computing application, by the expert user and with search results associated with the one or more searches.

9. The system of claim 1, comprising wherein the communications module is to communicate the on-line experience report to one or more follower users in response to a request initiated by the expert user.

10. A machine-readable non-transitory storage medium having instruction data to cause a machine to:
record user's notes provided by an expert user, the user's notes associated with on-line activities of the expert user;
detect a completion trigger, the completion trigger associated with the on-line activities of the expert user;
associate the notes with respective context information, the context information comprising; and
generate a report based on the user's notes; and
release the report to one or more follower users.

11. A method comprising:
commencing recording of user's notes provided by an expert user;
in response to detecting a completion trigger, associating the user's notes with an item and storing the user's notes;
generating, using at least one processor coupled to a memory, a report based on the shopping notes; and
releasing the report to one or more follower users.

12. The method of claim 11, comprising launching an on-line trading application at a server computer system, wherein:
the notes are shopping notes associated with an item offered for sale, the item listed by the on-line trading application; and
the completion trigger indicates a completed transaction with respect to the item.

13. The method of claim 12, comprising:
receiving, from a client computer system executing a browser application, a shopping note provided by the expert user;
collecting context information associated with the shopping note; and
recording the shopping note together with the context information,
wherein the generating of the shopping experience report comprises utilizing the shopping notes and the context information.

14. The method of claim 13, wherein the context information comprises a link to a web page associated with the shopping note.

15. The method of claim 13, wherein the context information comprises data from a web page associated with the shopping note.

16. The method of claim 12, wherein the generating of the shopping experience report comprises creating a list of the shopping notes.

17. The method of claim 12, wherein the generating of the shopping experience report comprises generating a video, the video annotated with the shopping notes.

18. The method of claim 12, wherein the recording of shopping notes is associated with one or more searches directed to the on-line trading platform by the expert user and with search results associated with the one or more searches.

19. The method of claim 12, comprising communicating the shopping experience report to one or more follower users in response to the completion trigger.

20. The method of claim 11, comprising communicating the report to a follower user in response to detecting a request from the expert user.
